(19) United States
(12) Patent Application Publication
(10) Pub. No.: US 2005/0121880 A1
(43) Pub. Date: Jun. 9, 2005

(54) Receiver tube mounted trailer hitch cover

(76) Inventor: Anthony Santangelo, Sicklerville, NJ (US)

Correspondence Address: Anthony Santangelo, 69 Scenic View Drive, Sicklerville, NJ, 08081-3011, US

(21) Appl. No.: 10/727,243

(22) Filed: Dec. 4, 2003

(51) Int. Cl. B60D 1/00

(52) U.S. Cl. 280/507

(57) ABSTRACT

This invention is an attractive cover for trailer hitch components which mounts on the receiver tube. It is especially useful for those vehicles whose trailer hitch is visible through an opening in the bumper fascia of the vehicle. These exposed components are generally unattractive. On these vehicles this invention will complete and fill-in the bumper fascia opening with a material that complements the vehicles own bumper covering. This invention mounts on the receiver tube and encloses and protects the receiver tube, safety chain anchors, electrical connections and other trailer hitch components. This invention will help to protect trailer components from blows and rough handling, corrosion, being clogged with mud and dirt and UV damage due to sunlight. It will prevent harm to people from striking the hitch and will smooth the outline of a vehicle reducing the turbulence around the vehicle and making it more gas efficient.

### CROSS REFERENCE TO RELATED APPLICATIONS

Please see the following applications for examples of the prior art in this area.

| | | | | | |
|---|---|---|---|---|---|
| 4955968 | 5037122 | 5407219 | 5560631 | 5593170 | 5934699 |
| d349083 | 4040641 | 4955968 | 5037122 | 5407219 | 5560631 |
| 5593170 | 5934699 | 6176506 | 6581952 | | |

### STATEMENT REGARDING FED SPONSORED R&D

Not Applicable.

### REFERENCE TO SEQUENCE LISTING, A TABLE, OR A COMPUTER LISTING APPENDIX

Not Applicable.

### FIELD OF THE INVENTION

The present invention is an attractive cover for trailer hitch components. It relates to trailer hitches, receiver tubes and other towing equipment and components. It also relates to molded bumpers, covers and fascias used in automotive applications.

### BACKGROUND OF THE INVENTION

In the past car and truck bumpers were made entirely of metal. Older cars could be jacked-up by their bumper or a trailer hitch could be attached directly to the bumper for light hauling. Their bumpers were strong enough to support these loads safely. Many modem cars and trucks no longer have bumpers made entirely of metal. The outside part you can see is merely a cover molded to match the body of the vehicle. This is the fascia of the bumper. This fascia is molded of a material that can be painted and finished to match the rest of the body and fades similarly so that the bumper fascia matches the rest of the body throughout a vehicles useful life. This fascia does not have the strength to directly support a jack or pull a trailer.

Under the fascia is the structural bumper, which is designed to absorb impacts and provide protection to the occupants of the vehicle in the event of a collision. This structural bumper, which may be a simple steel beam, is called the bumper reinforcement. In many vehicles a trailer hitch is an integral part of the bumper reinforcement. This type of trailer hitch is usually intended for light hauling. Heavy loads need a trailer hitch bolted securely to the frame of the vehicle. On some vehicles this type of trailer hitch may also be accessed through an opening in the bumper fascia. On many vehicles the soft bumper fascia surrounds almost all of the bumper reinforcement except for an opening left in the fascia to allow access to the trailer hitch receiver and other components that are integral with the bumper reinforcement.

This invention is an attractive cover for the trailer hitch and associated components such as the safety chain mounts and electrical connections. For vehicles with an opening in their bumper fascia for a trailer hitch, the cover of this invention would be designed to cover and fill-in the open space attractively. For vehicles that do not have an opening in the bumper covering, the trailer hitch is mounted above or below the bumper. This invention can be shaped to attractively cover the trailer hitch on these vehicles also.

The opening in the bumper fascia of some vehicles allows the understructure of the vehicle to be seen. The material the bumper reinforcement is made of and its method of construction are visible. This is not as an attractive an area as the rest of the vehicles body. This opening houses the trailer hitch receiver, anchors for safety chains and sometimes other components like electrical connections. On vehicles with this opening in the fascia, this unattractive area of the vehicle is always visible. This area is susceptible to the accumulation of dirt and mud, which may make the hitch unusable. The trailer hitch is susceptible to damage from blows or rough handling. The trailer hitch receiver is also susceptible to corrosion from being exposed to moisture. Any components contained within this opening may be susceptible to corrosion and damage without protection. This invention will enclose the bumper fascia opening with an attractive cover and provide protection for the trailer hitch components.

Although generally made of steel, the portion of the bumper reinforcement accessible through the opening in the bumper fascia is susceptible to a number of conditions that may limit its useful life or render the trailer connections non-functional. The receiver, electrical connections and chain anchors are susceptible to physical damage from impacts or rough handling. The wiring and electrical connections are susceptible to damage from the UV radiation in sunlight. A minor dent or damage to the trailer receiver will make the insertion of towing components like a drawbar very difficult. This invention will protect the trailer components from physical damage due to impacts and rough handling, from corrosion due to exposure to moisture and from damage by the UV radiation in sunlight.

The opening in the bumper fascia to allow access to a trailer hitch receiver usually also contains a provision for the trailer wiring. This wiring connects the vehicle to the trailer to provide electricity to illuminate the taillights and license plate light and illuminates the stoplights when the brakes are depressed. There are a wide variety of methods for making these electrical connections. These may consist of bare stripped wires that are attached to the trailer with pigtail type connectors. A simple electrical connector may also be used which consists of a coupling with male and female connectors. An electrical receptacle with a hinged cover may also be used on the vehicle into which a mating plug is inserted from the trailer. The electrical connections may comprise small easily damaged wires or components. These connections are susceptible to damage by dirt, mud and moisture rendering them inoperable. This invention would provide protection to trailer connectors and wiring thereby improving the quality of the electrical connections. This would improve the functioning of the lighting for the trailer and improve safety. Proper illumination would be provided at night, the brake lights would operate properly and any electrical braking devices would operate properly.

The current methods of protecting the trailer hitch receiver leave much to be desired. Although covers exist to protect the receiver tube opening alone, none offer protection to related towing components like electrical connections or safety chain anchors. Further, the currently available covers do not mount on the receiver tube and must be fixed in place using nylon ties or similar fastening methods. No currently available receiver covers have a cover that is molded to fit the opening in the bumper fascia of vehicles having such an opening.

Plug type hitch covers that fit the receiver opening do not protect the surface of the receiver hitch from corrosion by preventing contact with mud and moisture. They often provide little if any protection from damage due to blows and rough handling. Such plugs offer no protection for trailer wiring or safety chain anchors. Plug type receiver covers are not as aesthetically pleasing as the present invention and do not conform to the outline of the vehicle and the rest of the bumper cover.

The present invention will help solve many of the shortcomings in the available products. The present invention is a molded, semi-pliable design that can be made from materials such as plastic or the same material as the original bumper fascia such as urethane. This receiver mounted bumper cover can also be finished and painted to match the body color of the rest of the bumper cover or it can be made in a single color which complements the body color such as grey or black.

This invention, in its preferred embodiment, comprises a post for insertion into the trailer hitch receiver, with a molded cover extending from around the top of the post and designed to fit the bumper fascia opening in vehicles that have such an opening. It will have molded in flexible tabs for snapping into the holes in the trailer hitch receiver and/or holes to allow a pin to be passed through the bumper cover and then fixed with a cotter or hitch pin. It will protect and cushion the trailer hitch receiver tube from blows and rough handling. It will protect the entire opening from mud intrusion and will help protect from water damage and corrosion. It will prevent UV damage from exposure to sunlight. The present invention will help prevent the intrusion of mud, dirt, dust and moisture into the receiver hitch, electrical connectors, safety chain anchor and any and all connections within this opening. It will prevent injuries by covering protruding sharp edges with soft pliant material.

### BRIEF SUMMARY OF THE INVENTION

An object of the present invention is to provide protection against blows or rough handling of the trailer hitch receiver, electrical connections and safety chain anchors.

Another object of the present invention is to provide a cover that attractively covers and completes the bumper fascia opening in vehicles with such an opening.

Yet another object of the present invention is to provide protection to the trailer hitch components, electrical connections and safety chain anchors from damage from mud, dirt, dust and moisture.

Yet another object of the present invention is to smooth the outside of the vehicle thereby lowering the vehicles drag coefficient, lessen the turbulence created in the air by the moving vehicle and increasing the gas mileage of the vehicle upon which it is used.

Yet another object of the present invention is to prevent UV damage to trailer hitch components from exposure to sunlight.

Yet another object of the present invention is to have a molded in tabs that will snap into holes or depressions in the trailer hitch receiver and secure it.

Yet another object of the invention is to help prevent injury by preventing a person's leg from striking the sharp metal edges of the trailer hitch.

According to one preferred embodiment, the present invention consists of a single piece made from a material such as plastic or urethane resin but any other known to one skilled in the art may be used. In this embodiment the invention is molded to incorporate a square post that fits the interior of a trailer hitch receiver snugly and is retained by either molded in tabs or with a pin passed through holes in the invention aligned with holes in the receiver tube and fastened with a cotter pin. An attractive cover or enclosure will extend around the top of the post to cover, enclose and protect trailer hitch components. This cover will be designed to complete attractively the opening in a bumper fascia of vehicles having such an opening. This cover will be pleasingly designed to blend in and complete the body or bumper covering around the previously uncovered bumper reinforcement structure.

This invention will incorporate molded-in reinforcements in its production to increase its rigidity and prevent vibrations or resonances while in use and from air currents. This invention will also incorporate molded in wells and depressions that fit around and protect underlying components under the bumper cover such as electrical connectors and safety chain anchors. To use this invention it is inserted in to the trailer hitch receiver until the molded in tabs snap into place or a pin is used to secure it by putting a suitable pin through the invention and through the trailer hitch receiver and securing with a cotter pin or hitch pin. To remove the invention so that accessories may be inserted into the receiver tube, depress the tabs or pull on the invention to disengage the tabs from their depressions or remove the retaining pin and slide the invention out of the receiver.

### BRIEF DESCRIPTION OF THE DRAWINGS

FIGS. 1 and 2 and 3 and 4 show the Receiver Tube Mounted Trailer Hitch Cover. FIG. 1 provides a trimetric of the invention. FIG. 2 shows a top view of the invention FIG. 3 shows a side view of the invention. FIG. 4 shows a rear view of the invention. The component marked 1 is the post of the invention. The component marked 2 is the cover of the invention.

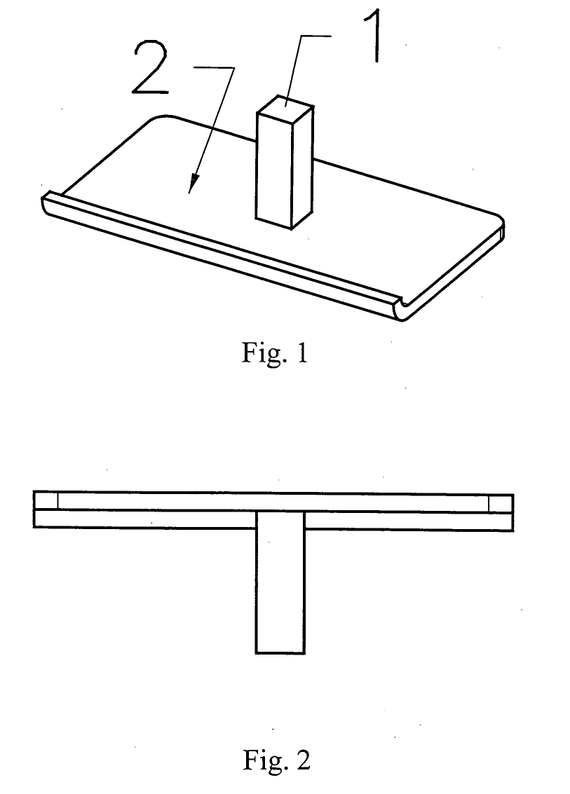

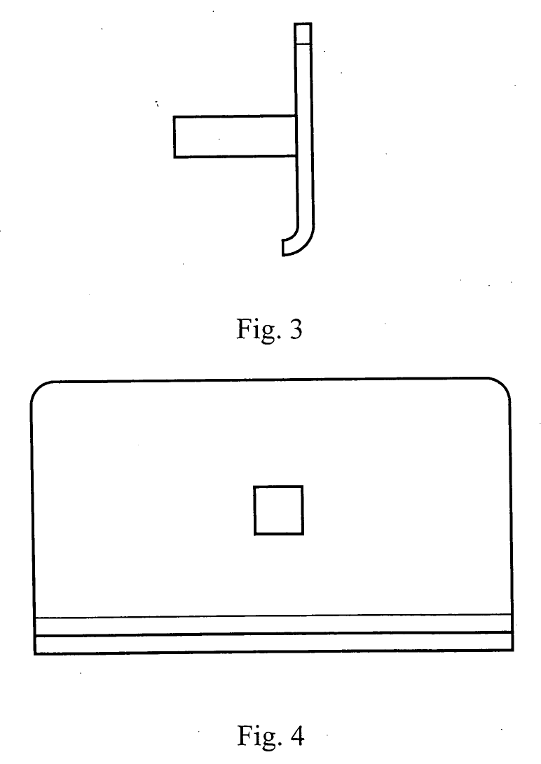

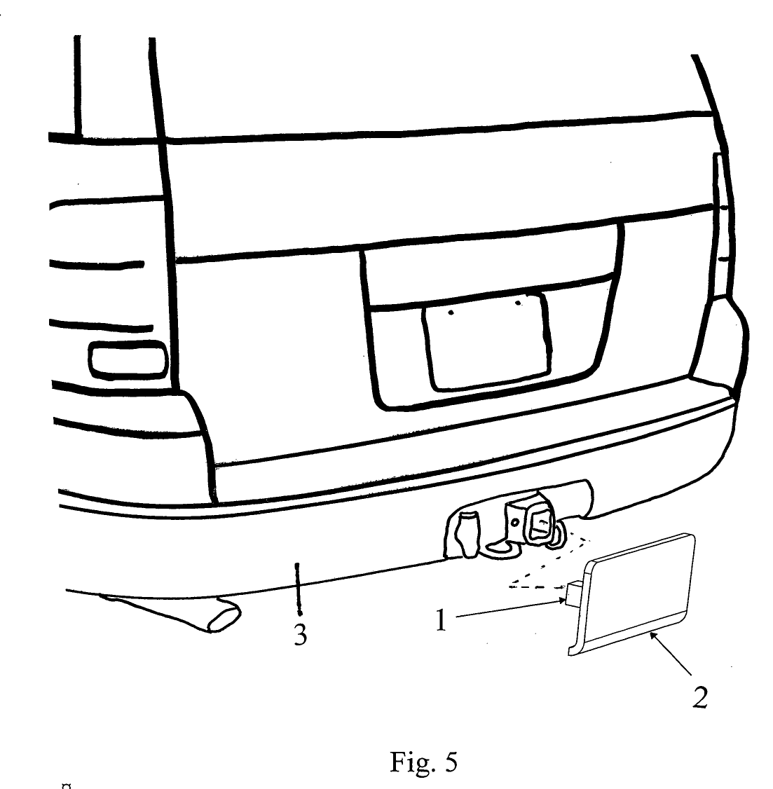

### DETAILED DESCRIPTION OF THE INVENTION

According to one preferred embodiment, the present invention consists of a single piece made from a moldable material such as plastic or urethane resin but any other known to one skilled in the art may be used. This material may be the same as the vehicles bumper fascia to allow the same finishing and painting techniques to be used and that the paint on the bumper cover and this invention will fade at the same rate thereby matching for the life of the vehicle. If the same material is used similar expansion and contraction characteristics will insure the bumper cover and this invention fit properly throughout their useful life.

In this embodiment the invention is molded to incorporate a square post 1 that fits the interior of a trailer hitch receiver snugly and is retained by either molded in tabs or with a pin that goes through molded in holes in the invention. A cover 2 will be fixed to the top of the post, which will be designed to cover, enclose and protect trailer hitch components. This cover 2 will closely fit with the opening in a bumper fascia of a particular vehicle having this opening. This cover 2 will be pleasingly designed to blend in, complete or complement the body shape or bumper fascia around the trailer hitch receiver structure. This cover will be designed to cover and protect the components used for towing including the receiver, the electrical connections and safety chain anchors if included.

When this invention is fitted to a vehicle the cover will seal out mud, dirt, dust, light or moisture to prevent corrosion, UV damage and prevent dirt from rendering these components inoperable. When this invention is attached the resilient material it is created from will protect the trailer hitch receiver, electrical connections and safety chain anchors from damage due to blows or rough handling. This invention will incorporate molded-in reinforcements in its production to increase its rigidity and prevent vibrations or resonances while in use and from air currents. This invention will also incorporate molded in wells and depressions that fit around and protect underlying components under the bumper cover such as electrical connectors and safety chain anchors.

To use this invention it is inserted into the trailer hitch receiver tube until the molded in tabs snap into place or a pin is used to secure it by putting a suitable pin through the invention and through the trailer hitch receiver and securing with a cotter pin or hitch pin. To remove the invention, pull the invention away from the vehicle. This will cause the locking tabs to be displaced from their previous position in holes or depressions in the receiver tube. If a retaining pin were used instead, the invention would be removed by removing the cotter or pin securing the pin and remove the retaining pin and slide the invention out of the receiver.

1. (canceled)

2. (canceled)

3. (canceled)

4. (canceled)

5. What is claimed is an apparatus for protecting trailer hitch components in use on motor vehicles comprising:
(a) a cover, molded to a shape which will cover, enclose and protect the trailer hitch receiver, safety chain anchors and electrical connections as used on motor vehicles from dirt, mud, moisture and sunlight; and
(b) fixed to the cover, a means of attaching the cover to a trailer hitch receiver tube.

6. A cover as defined in claim 1 wherein the means of attachment to a trailer hitch receiver tube comprises a square post of a predetermined size that fits snugly into the interior of a trailer hitch receiver tube.

7. A cover as defined in claim 1 wherein the cover completes and closes the opening in a vehicle bumper fascia.

8. A cover as defined in claim 1 wherein the cover attractively complements the bumper fascia of a vehicle.

9. A cover as defined in claim 1 wherein the cover is rectangular in shape further comprises a lower edge curved inward.
